(19) United States
(12) Patent Application Publication
(10) Pub. No.: US 2008/0147984 A1
(43) Pub. Date: Jun. 19, 2008

(54) Method and apparatus for faster execution path

(76) Inventors: Gazala Khan, Cupertino, CA (US); Saleem Mohideen, Cupertino, CA (US); Manish Ahluwalia, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/591,010

(22) Filed: Oct. 31, 2006

(51) Int. Cl. G06F 13/28

(52) U.S. Cl. 711/135

(57) ABSTRACT

In accordance with one embodiment, execution of a first instance of a binary program is begun, and program header table data is read for the binary program from a binary file on disk storage. The program header table data is stored in cache memory for use by subsequent instances of the binary program. In accordance with another embodiment, execution of a binary program is begun. A flush procedure is applied. The flush procedure relates to flushing pages in a file cache that correspond to the binary file prior to continuing with the execution of the binary program. Other features and embodiments are also disclosed.

### BACKGROUND

1. Field of the Invention

The present application relates generally to computer systems and software. More particularly, the present application relates to computer operating systems with virtual memory.

2. Description of the Background Art

Computer systems typically include a processor and a main memory. The main memory functions as the physical working memory of the computer system, where data is stored that has been or will be used by the processor and other system components.

In computer systems that implement “virtual memory,” software programs executing on the computer system reference main memory through the use of virtual addresses. A memory management unit (“MMU”) translates each virtual address specified by a software program instruction to a physical address that is passed to the main memory in order to retrieve the requested data. The use of virtual memory permits the size of programs to greatly exceed the size of the physical main memory and provides flexibility in the placement of programs in the main memory.

Implementing a virtual memory system requires establishing a correspondence between virtual address space and physical address space in the main memory. A common technique by which to have virtual address space correspond with physical address space involves separately dividing virtual address space and its corresponding physical address space into contiguous blocks called pages. Each page has a virtual page number address in virtual address space that corresponds to the physical page number address of the page in physical address space.

For each access to main memory, a virtual page number address in virtual address space is translated into the corresponding physical page number address in physical address space, and a page offset within the physical page is appended to the physical page number address. Thus, the virtual address subdivided into a Virtual Page Number Address:Page Offset is translated into a physical address consisting of Physical Page Number Address:Page Offset. The physical address is then used to access main memory. Translation of the virtual page number address into its corresponding physical page number address occurs through the use of page tables stored in physical main memory.

In order to reduce the total number of page table main memory accesses required per virtual-to-physical address translation, one or more translation-lookaside buffers (TLBs) are often provided in the MMU. A TLB is a cache-like memory, typically implemented in Static Random Access Memory (“SRAM”) and/or Content Addressable Memory (“CAM”), that holds virtual page number address to physical page number address translations that have recently been fetched from the page table in physical main memory. Access to a TLB entry holding an output physical page number address corresponding to an input virtual page number address obviates the need for, and is typically significantly faster than, access to the page table in main memory. Hence, TLB accesses reduce the overall average time required to perform the steps of a virtual-to-physical address translation.

If the TLB does not contain the requested translation (i.e., a TLB “miss” occurs) then the MMU initiates a search of page tables stored in main memory for the requested virtual page number address. A TLB miss handler then loads the physical page number address referenced by the virtual page number address into the TLB, where it may be available for subsequent fast access should translation for the same input virtual page number address be required at some future point.

One solution to reduce translation lookaside buffer misses is to use larger page sizes so that the same physical main memory can be described by many fewer virtual page number addresses. TLB misses for a system with large page sizes are much less likely. For example, if the small page sizes are such that physical main memory can be mapped into a total of 64 pages while the TLB can only hold 16 virtual-to-physical page translations, then a random TLB access will miss 75% of the time. Alternatively, if the virtual memory system is implemented with large page sizes such that physical main memory can be mapped into a total of 32 pages while the TLB can still hold 16 virtual-to-physical page translations, then a random TLB access will miss only 50% of the time.

However, large page sizes result in more complex hardware to access the page offset within the physical page and also increase unused space within the pages (due to internal fragmentation). For this reason, high-performance processors generally allow any of a plurality of page sizes to be selected for different purposes.

It is highly desirable to improve performance of computer systems and software. More particularly, it is highly desirable to improve performance of computer operating systems with virtual memory.

### BRIEF DESCRIPTION OF THE DRAWINGS

FIG. 1 is a schematic diagram depicting select components of a memory system for purposes of discussion.

FIG. 2A is a chart showing a conventional process flow during execution of a first instance of a binary file, including certain disadvantageous aspects of that process relating to binary text fragmentation.

FIG. 2B is a chart showing a conventional process flow during execution of a second (or greater) instance of a binary file, including certain disadvantageous aspects of that process relating to binary text fragmentation and unnecessary reads of executable header data.

FIG. 2C is another chart showing a binary text fragmentation problem.

FIGS. 3A and 3B are flow charts depicting a method for executing multiple instances of a binary file in accordance with an embodiment of the invention.

FIG. 4 is a brief flow chart showing a method of maintaining the integrity of cached header data in accordance with an embodiment of the invention.

FIG. 5 is a flow chart depicting a process flow for a flush procedure in accordance with an embodiment of the invention.

FIG. 6 is a schematic diagram depicting a memory mapping restriction which may be advantageously avoided in accordance with an embodiment of the invention.

### DETAILED DESCRIPTION

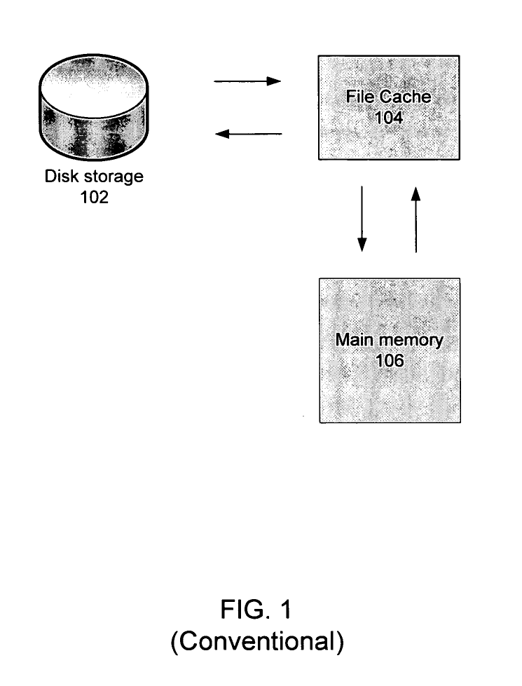

FIG. 1 is a schematic diagram depicting select components of a memory system for purposes of discussion. Shown in FIG. 1 are disk storage 102, file cache 104, and main memory 106 components.

Main memory 106 generally comprises physical memory in the form of random access memory (RAM) that is internal to the computer system. Since the amount of main memory 106 is typically limited, disk storage 102 is used for additional data storage. Disk storage 102 refers to an external mass storage device, typically one or more disk drives, which store computer-readable data.

Prior to being accessed by the main processor, a file is generally copied into main memory 106. For example, when a binary program file is to be executed, it is typically copied from disk storage 102 into main memory 106.

A file cache 104 may be utilized to speed up access to files in the disk storage 102. The file cache 104 is typically implemented using RAM and configured to store segments of active files in anticipation of future requests. The file cache 104 speed access to files that are used by multiple users or multiple applications. Requests to access files are diverted to check the file cache 104 prior to accessing them from the disk storage 102. If the data requested is already in the file cache 104, then there is a cache hit, and it is not necessary to access the relatively slow disk storage 102. On the other hand, if the data requested is not in the file cache 104, then there is a cache miss. In the event of a cache miss, the requested data may be read from the disk storage 102 to the file cache 104, and then accessed by the main memory 106 from the file cache 104.

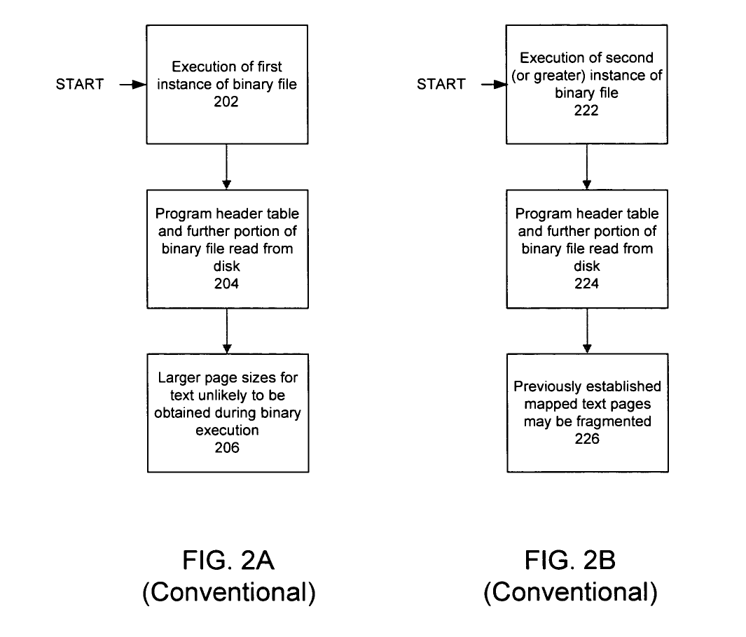

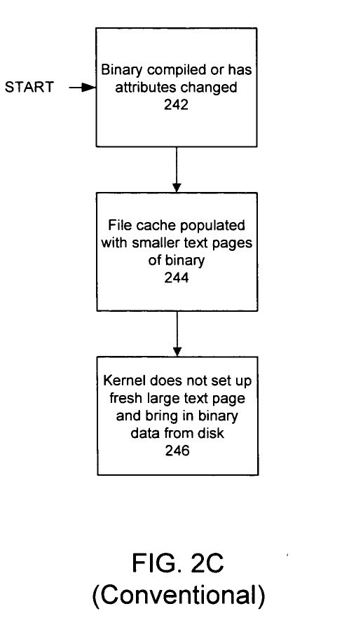

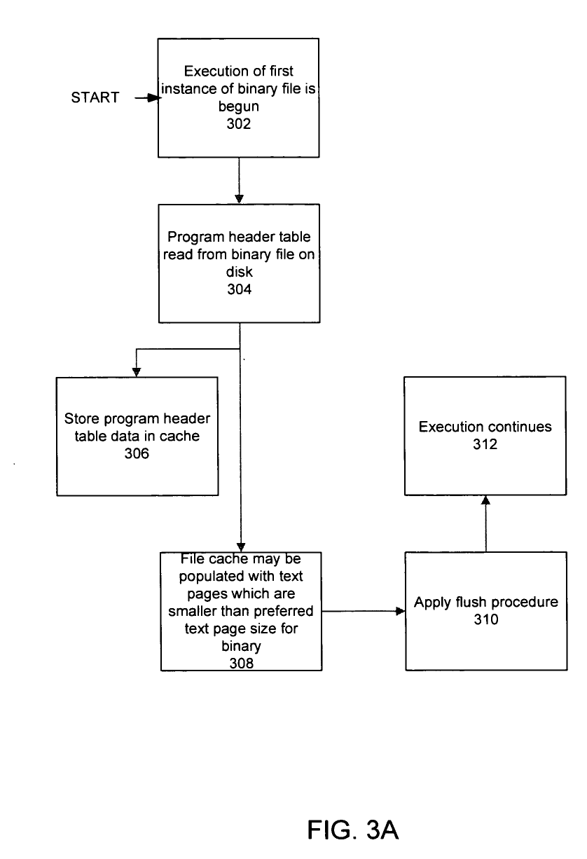

FIG. 2A is a chart showing a conventional process flow during execution of a first instance of a binary file, including certain disadvantageous aspects of that process relating to binary text fragmentation. The process starts in the first block 202 where execution of a first instance of a binary file is begun.

At the execution of the binary file, the operating system kernel reads a program header table of the file from disk storage 102 and may also bring in a further portion of the binary file, as shown in the second block 204. If the portion read overlaps with the text segment of the binary, then it will be unlikely to get large pages for text later when the binary executes, as shown in the third block 206.

FIG. 2B is a chart showing a conventional process flow during execution of a second (or greater) instance of a binary file, including certain disadvantageous aspects of that process relating to binary text fragmentation and unnecessary reading of executable header data. The process starts in the first block 222 where execution of a second (or greater) instance of a binary file is begun.

At the execution of the binary file, the operating system kernel again reads a program header table and a further portion of the file from disk storage 102, as shown in the second block 224. As shown in the third block 226, this may result in previously established mapped text pages (by the first instance of the binary) being fragmented or demoted to smaller page sizes.

FIG. 2C is another chart showing a binary text fragmentation problem. When a binary file is compiled or has its attributes changed, as shown in the first block 242, the file cache 104 may be populated with text at smaller page sizes than a preferred text page size attributed to the binary file, as shown in the second block 244. Because the smaller text pages of the binary file are already in the file cache 104, the kernel does not bother to set up a fresh large page and bring in binary data from the disk storage 102, as shown in the third block 246.

As discussed above, execution performance may be slowed by binary text fragmentation and unnecessary reads to executable header data. Solutions to the aforementioned problems are described below.

Applicants have determined certain circumstances and problems which hinder the performance of program execution in at least some computer operating systems. These circumstances and problems may lead to binary text fragmentation and unnecessary reads of executable header data.

For example, reasons leading to binary text fragmentation may include the following. First, compiling and/or changing an attribute of a binary file will typically bring text pages into the file cache, where the text pages may have a much smaller page size than the preferred text page size which is desired when the binary executes. Since these smaller pages of the binary are already in the file cache, the kernel may not bother to set up a fresh large page and bring in binary data from disk storage. Second, the first execution (the first instance) of a binary typically does a read for the program header table which may bring in a portion of the binary with a smaller page size, and the presence of the smaller page size may prevent text from getting a larger page later during execution. Third, at the first execution (the first instance) of the binary, the text segment is mapped into the process address space. Executing the binary a second time (the second instance) results in reading the program header table from the binary file on disk storage. This may cause the already established mapped text pages (by the first instance of the binary) to get fragmented.

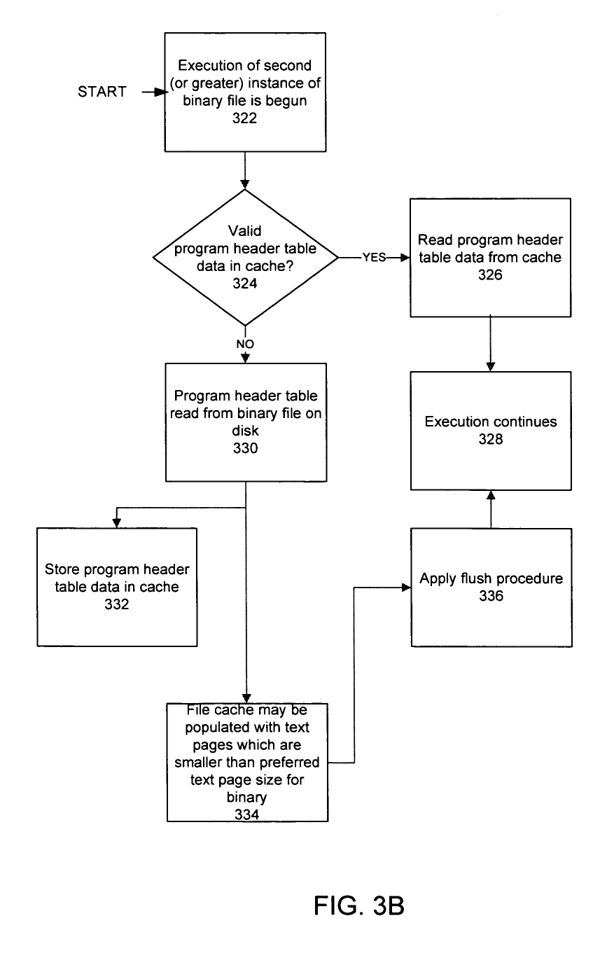

FIG. 3A is a flow chart depicting a method for executing a first instance of a binary program in accordance with an embodiment of the invention. The process starts in the first block 302 where execution of a first instance of the binary file is begun. As shown in the second block 304, the operating system kernel reads the program header table from the binary file in the disk storage 102.

In accordance with an embodiment of the invention, per the third block 306, program header table data (that was just read) is stored in cache memory and associated with the binary file. As shown in the fourth block 308, reading the program header table from the disk storage 102 often results in the file cache 104 being populated with text at smaller page sizes than a preferred text page size attributed to the binary file.

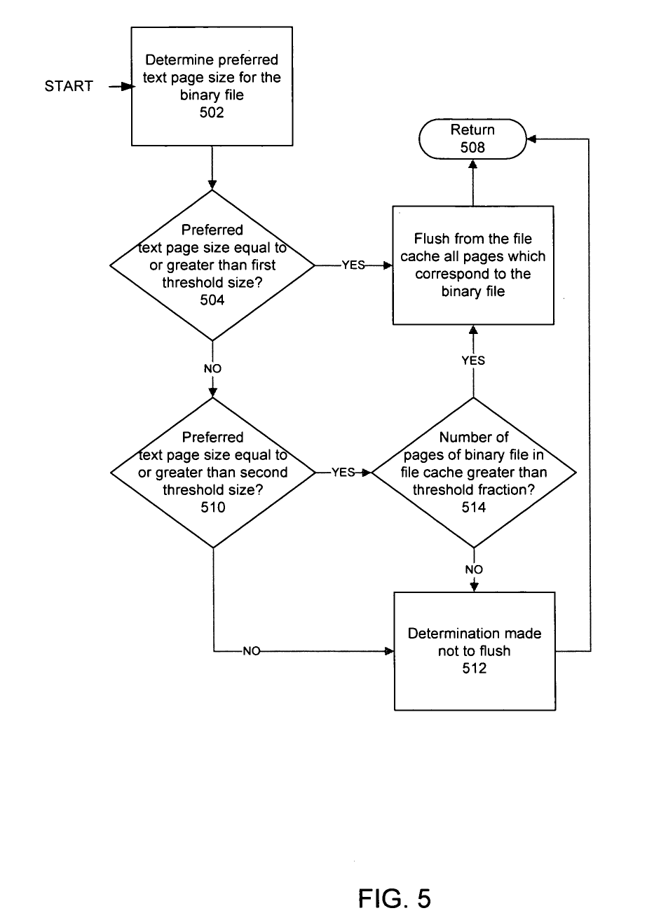

In accordance with an embodiment of the invention, a flush procedure is then applied per the fifth block 310 to pages in the file cache 104 that correspond to the binary file. An embodiment of the flush procedure is described further below in relation to FIG. 5. Advantageously, the flush procedure may be applied to flush smaller text pages from the file cache 104, allowing subsequent use of larger text page sizes during execution of the binary. Thereafter, the execution of the binary continues per the sixth block 312.

FIG. 3B is a flow chart depicting a method for executing a second (or greater) instance of a binary program in accordance with an embodiment of the invention. The process starts in the first block 322 where execution of a second or greater instance of the binary file is begun. As shown in the second block 324, a determination is then made by the operating system kernel as to whether valid program header table data for the binary file is already stored in cache memory.

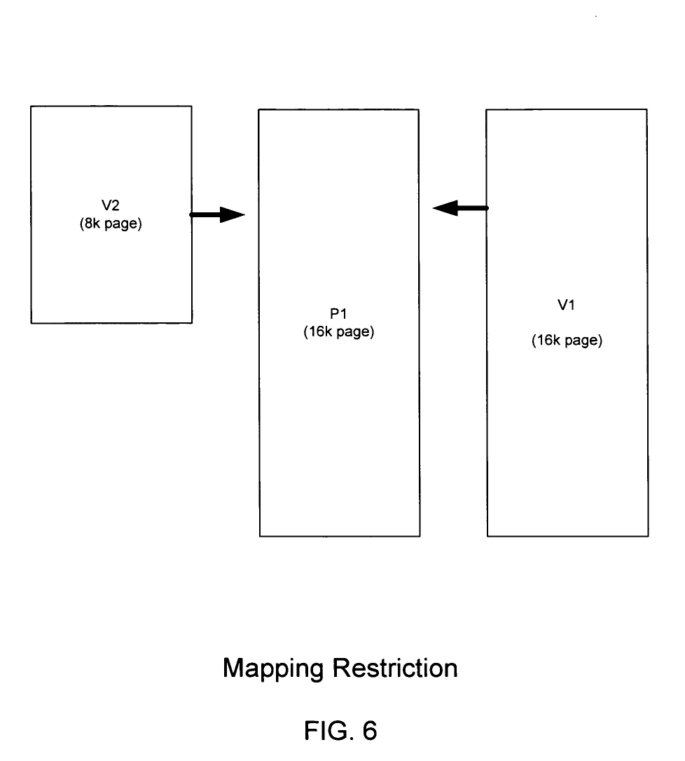

If valid program header table data is cached, then the kernel bypasses reading the program header table from the binary file in the disk storage 102. Instead, the kernel retrieves the program header table data from the cache, as indicated in the third block 326. Advantageously, this avoids previously mapped text pages from being fragmented as a result of smaller text pages being read into the file cache 104 from the disk storage 102. Such fragmentation of previously mapped text pages is discussed further below in relation to FIG. 6. In addition, reading the cached program header table data advantageously speeds up the execution path as a slower read of that data from disk storage 102 is avoided. Also, since the cached program header table data has already gone through a lot of logical error checking (“sanity” checking), these checks may be advantageously avoided in subsequent executions. Thereafter, the execution of the binary continues per the fourth block 328.

On the other hand, if valid program header table data is not cached, then, as shown in the fifth block 330, the kernel goes ahead and reads the program header table from the binary file in the disk storage 102. In accordance with an embodiment of the invention, per the sixth block 332, program header table data (that was just read) is stored in cache memory and associated with the binary file. As shown in the seventh block 334, reading the program header table from the disk storage 102 often results in the file cache 104 being populated with text at smaller page sizes than a preferred text page size attributed to the binary file.

In accordance with an embodiment of the invention, a flush procedure is then applied per the eighth block 336 to pages in the file cache 104 that correspond to the binary file. An embodiment of the flush procedure is described further below in relation to FIG. 5. Advantageously, the flush procedure may be applied to flush smaller text pages from the file cache 104, allowing subsequent use of larger text page sizes during execution of the binary. Thereafter, the execution of the binary continues per the fourth block 328.

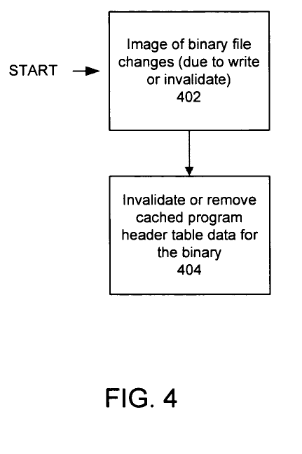

FIG. 4 is a brief flow chart showing a method of maintaining the integrity of cached header data in accordance with an embodiment of the invention. Per the first block 402, the image of the binary file may change, for example, due to a write to the file or an invalidate. In accordance with an embodiment of the invention, whenever the image of the binary file is changed, then the cached program header table data is invalidated or removed from the cache per the second block 404. This advantageously maintains the integrity of the cached header data which is utilized per the method of FIG. 3.

FIG. 5 is a flow chart depicting a process flow for a flush algorithm in accordance with an embodiment of the invention. The flush algorithm determines whether or not to flush the file cache of pages corresponding to a binary file. Such a flush algorithm may be applied, for example, per the seventh block 314 in the method of FIG. 3.

In the first block 502 of the flush algorithm, a determination is made as to the preferred text page size for the binary file. A binary file may have internal characteristics, including preferred page sizes (page size hints) for its text and data segments. These internal characteristics may be set or changed, for example, by using a “chatr” (change attribute) command in the HP-UX operating system. The preferred text page size may be determined from the program header table (i.e. in the executable header).

In the second block 504, a determination is made as to whether the preferred text page size for the binary is greater than or equal to a first threshold size. The first threshold size may be a predetermined size, for example, 256 kilobytes. The predetermined size may be pre-set depending on system parameters, such as the size of the file cache and other parameters.

If the preferred text page size is greater than or equal to the first threshold size, then the process goes on to the third block 506 where all text pages which correspond to the binary file are flushed (i.e. removed or invalidated) from the file cache 104. Advantageously, flushing the file cache of these text pages allows text to get larger page sizes later during execution of the binary. Thereafter, the process returns to the calling routine, as indicated by the fourth block 508.

On the other hand, if the preferred text page size is less than the first threshold size, then the process goes on to the fifth block 510 where a determination is made as to whether the preferred text page size for the binary is greater than or equal to a second threshold size, where the second threshold size is a fraction of the first threshold size. Like the first threshold size, the second threshold size may be a predetermined size, for example, 64 kilobytes. The predetermined size may be pre-set depending on system parameters, such as the size of the file cache and other parameters.

If the preferred text page size is less than the second threshold size, then the process goes on to the sixth block 512 and makes the determination not to flush the file cache 104. For example, if the second threshold size is 64 kilobytes, then the decision not to flush would be made if the preferred text page size is less than 64 kilobytes. In that case, the preferred text page size is small enough such that flushing the file cache 104 is unnecessary or is unlikely to be of significant benefit. Thereafter, the process returns to the calling routine, as indicated by the fourth block 508.

On the other hand, if the preferred text page size is greater than or equal to the second threshold size, then the process goes on to the seventh block 514 where a determination is made as to whether the number of pages of the binary file already in the file cache 104 is greater than a predetermined threshold fraction of the total pages of the binary file. The predetermined threshold fraction may be, for example, one quarter or some other fraction.

If more than the threshold fraction of pages of the binary file are already in the file cache 104, then the process goes back to the third block 506 where all text pages which correspond to the binary file are flushed (i.e. removed or invalidated) from the file cache 104. Advantageously, flushing the file cache of these text pages makes it much more likely for text to get larger page sizes later during execution of the binary. Thereafter, the process returns to the calling routine, as indicated by the fourth block 508.

On the other hand, if less than the threshold fraction of pages of the binary file are already in the file cache 104, then the process goes to the sixth block 512 and makes the determination not to flush the file cache 104. Thereafter, the process returns to the calling routine, as indicated by the fourth block 508.

FIG. 6 is a schematic diagram depicting a memory mapping restriction which may be advantageously avoided in accordance with an embodiment of the invention. In at least some operating systems, there is a memory mapping restriction that two virtual pages with different sizes are now allowed. Such a memory mapping restriction causes fragmentation of previously mapped text pages when smaller text pages are read from disk storage 102.

For example, in FIG. 6, a first virtual page V1 is shown. This first virtual page V1 may be a larger sized text page relating to a first execution instance. For example, V1 may be a virtual page which is 16 k in size. V1 is shown as being mapped to a physical page P1. Here, P1 is also a relatively large sized page. For example, P1 may be a physical page which is also 16k in size.

Subsequently, during a second execution instance, a second virtual text page V2 may be read from disk. The second virtual page V2 may be a smaller sized page relating to the second execution instance. For example, V2 may be a virtual page which is only 8 k in size. Due to the aforementioned memory mapping restriction, however, both V1 and V2 cannot be mapped to P1. This is because V1 and V2 have different page sizes. As a result, the kernel resolves this problem by fragmenting V1 into smaller text page fragments.

In one particular instance, V1 may include header data from the executable file as mapped by the first execution instance, and V2 may include header data from the executable file as mapped by the second execution instance. If V2 has a smaller text page size than V1 (as shown in FIG. 6), then V1 may be undesirably fragmented into smaller text page sizes.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of executing a binary program by a computer system, the method comprising:
beginning execution of a first instance of the binary program;
reading program header table data for the binary program from a binary file on disk storage; and
storing the program header table data in cache memory for use by subsequent instances of the binary program.

2. The method of claim 1, further comprising:
applying a flush procedure relating to flushing pages in a file cache that correspond to the binary file prior to continuing with execution of said first instance.

3. The method of claim 2, wherein the flush procedure makes a determination whether or not to flush said pages.

4. The method of claim 3, wherein the flush procedure makes the determination to flush said pages if a preferred text page size for the binary file is greater than a first threshold size.

5. The method of claim 4, wherein the flush procedure makes the determination not to flush said pages if the preferred text page size is less than a second threshold size, wherein the second threshold size is smaller than the first threshold size.

6. The method of claim 5, wherein if the preferred text page size is in between the first and second threshold sizes, then the flush procedure makes a further determination as to whether a number of pages of the binary file in the file cache is greater than a threshold fraction and, if so, flushes the pages in the file cache that correspond to the binary file.

7. The method of claim 1, further comprising invalidating or removing the program header table data in the cache memory if an image of the binary file changes.

8. The method of claim 1, further comprising:
beginning execution of a second instance of the binary program; and
if the program header table data for the binary program in the cache memory is valid, then reading the program header table data for the binary program from the cache memory for said second instance.

9. The method of claim 8, further comprising:
if the program header table data for the binary program in the cache memory is invalid, then reading the program header table data for the binary program from the disk storage for said second instance, and storing the program header table data in the cache memory.

10. The method of claim 9, further comprising applying a flush procedure relating to flushing pages in a file cache that correspond to the binary file prior to continuing with execution of said second instance.

11. A process of executing a binary program by a computer system, the process comprising:
beginning execution of the binary program; and
applying a flush procedure relating to flushing pages in a file cache that correspond to the binary file prior to continuing with the execution of the binary program.

12. The process of claim 11, wherein the flush procedure makes a determination whether or not to flush said pages.

13. The process of claim 12, wherein the flush procedure makes the determination to flush said pages if a preferred text page size for the binary file is greater than a first threshold size.

14. The process of claim 13, wherein the flush procedure makes the determination not to flush said pages if the preferred text page size is less than a second threshold size, wherein the second threshold size is smaller than the first threshold size.

15. The process of claim 14, wherein if the preferred text page size is in between the first and second threshold sizes, then the flush procedure makes a further determination as to whether a number of pages of the binary file in the file cache is greater than a threshold fraction and, if so, flushes the pages in the file cache that correspond to the binary file.

16. A computer apparatus comprising:
at least one processor for executing computer-readable code;
disk storage for storing computer-readable data;
cache memory for temporarily storing computer-readable data;
an operating system comprising computer-readable code;
computer-readable code in the operating system which is configured, upon execution of a first instance of the binary program, to read program header table data for the binary program from a binary file on the disk storage;
computer-readable code in the operating system which is configured to save the program header table data in the cache memory; and
computer-readable code in the operating system which is configured, upon execution of a second instance of the binary program, to read the program header table data for the binary program from the cache memory if the program header table data for the binary program in the cache memory is valid.

17. The computer apparatus of claim 16, further comprising:
computer-readable code in the operating system which is configured to apply a flush procedure relating to flushing pages in a file cache that correspond to the binary file.

18. The computer apparatus of claim 17, wherein the flush procedure makes a determination to flush said pages if a preferred text page size for the binary file is greater than a first threshold size.

19. The computer apparatus of claim 18, wherein the flush procedure makes a determination not to flush said pages if the preferred text page size is less than a second threshold size, wherein the second threshold size is smaller than the first threshold size.

20. The computer apparatus of claim 19, wherein if the preferred text page size is in between the first and second threshold sizes, then the flush procedure makes a further determination as to whether a number of pages of the binary file in the file cache is greater than a threshold fraction and, if so, flushes the pages in the file cache that correspond to the binary file.
